(19) United States
(12) Patent Application Publication
(10) Pub. No.: US 2003/0184515 A1
(43) Pub. Date: Oct. 2, 2003

(54) Computer user input assembly with wired and wireless transmission capability

(76) Inventor: Huo-Lu Tsai, Taichung Hsien (TW)

Correspondence Address: LOWE HAUPTMAN GILMAN & BERNER LLP, SUITE 310, 1700 DIAGONAL ROAD, ALEXANDRIA, VA, 22314, US

(21) Appl. No.: 10/112,763

(22) Filed: Apr. 2, 2002

(51) Int. Cl. G09G 5/00

(52) U.S. Cl. 345/156

(57) ABSTRACT

A computer user input assembly with wired and wireless transmission capability includes an input device and a control box. The input device has a rechargeable battery and a first switching unit operable between wireless and wired transmission modes. The control box has a second switching unit operable between the wireless and wired transmission modes, and a charging unit to charge the rechargeable battery of the input device when the charging unit is connected to an external power supply via a charging cable, and when first and second switching units operate in the wired transmission mode.

### BACKGROUND OF THE INVENTION

1. Field of the Invention

The invention relates to a computer user input assembly, more particularly to a computer user input assembly with wired and wireless transmission capability.

2. Description of the Related Art

A conventional computer user input assembly, such as a keyboard or a mouse, transmits a user input signal via a cable that connects the input assembly to a computer. However, the convenience of such a wired input assembly is limited due to length restrictions of the cable. A computer user input assembly with wireless transmission capability is known in the art. However, the conventional input assembly with wireless transmission capability is battery-operated and thus requires frequent battery replacement to prevent wireless transmission from being undesirably interrupted.

### SUMMARY OF THE INVENTION

Therefore, the object of the present invention is to provide a computer user input assembly which has wired and wireless transmission capability, and which is clear of the aforesaid drawbacks of the prior art.

Accordingly, the computer user input assembly with wired and wireless transmission capability of this invention includes an input device and a control box.

The input device includes an input unit operable so as to generate a user input signal, a wireless transmitter, a first cable connecting port, a first switching unit electrically connected to the input unit, the wireless transmitter and the first cable connecting port, and a battery electrically connected to the first switching unit for supplying electrical power to the input device. The first switching unit is operable in a wireless transmission mode, wherein the user input signal from the input unit is transmitted wirelessly via the wireless transmitter, and a wired transmission mode, wherein wired transmission of the user input signal from the input unit is permitted via the first cable connecting port.

The control box includes a computer connecting port adapted to be electrically connected to a computer, a wireless receiver for receiving the input signal wirelessly transmitted by the wireless transmitter, a second cable connecting port, a cable, and a second switching unit connected electrically to the computer connecting port, the wireless receiver and the second cable connecting port. The cable has a first end connected removably to the first cable connecting port, and a second end connected to the second cable connecting port. The cable permits wired transmission of the user input signal from the first cable connecting port to the second cable connecting port. The second switching unit is operable in a wireless transmission mode, wherein the user input signal received by the wireless receiver is provided to the computer connecting port, and a wired transmission mode, wherein the user input signal received by the second cable connecting port is provided to the computer connecting port.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of a computer user input assembly with wired and wireless transmission capability according to this invention;

FIG. 2 is a schematic circuit block diagram illustrating a wireless operation of the preferred embodiment of FIG. 1;

FIG. 3 is a schematic circuit block diagram illustrating a wired operation of the preferred embodiment of FIG. 1; and

FIG. 4 is a schematic circuit block diagram illustrating a charging operation of the preferred embodiment of FIG. 1.

### DETAILED DESCRIPTION OF THE PREFERRED EMBODIMENT

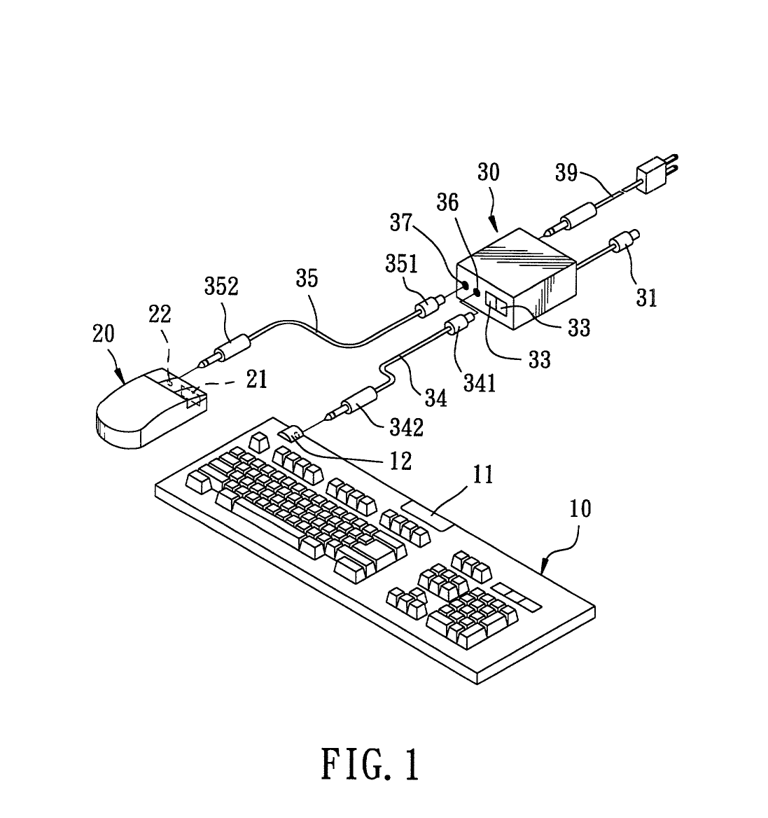

Referring to FIGS. 1, 2 and 3, the preferred embodiment of the computer user input assembly with wired and wireless transmission capability according to this invention is connectable to a computer 200, and includes a first input device 10, a second input device 20 and a control box 30.

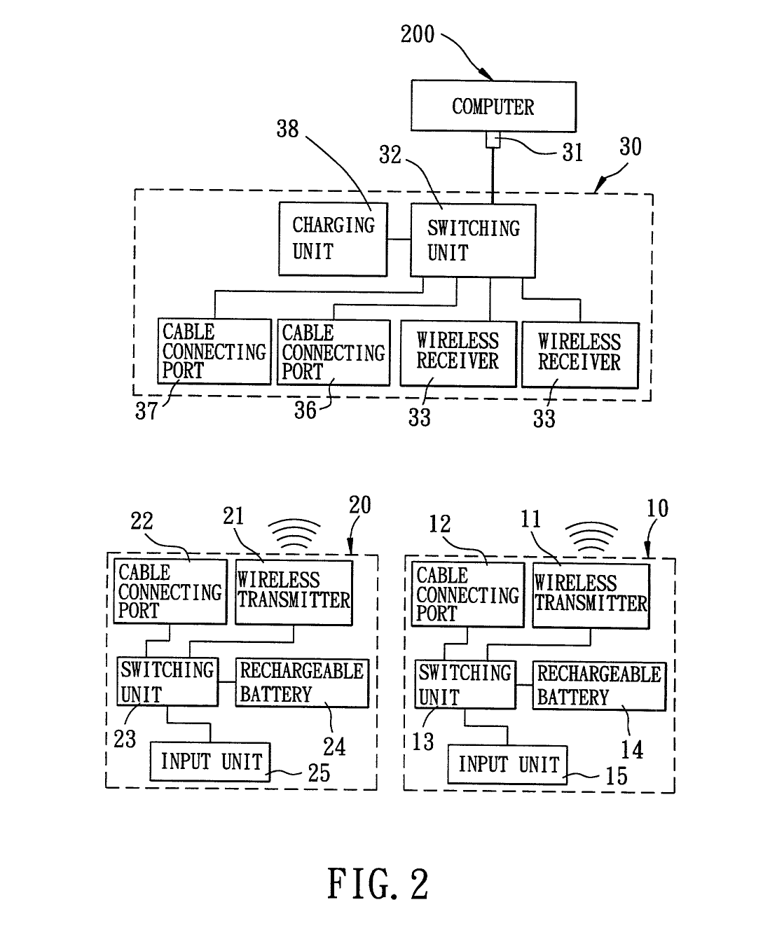

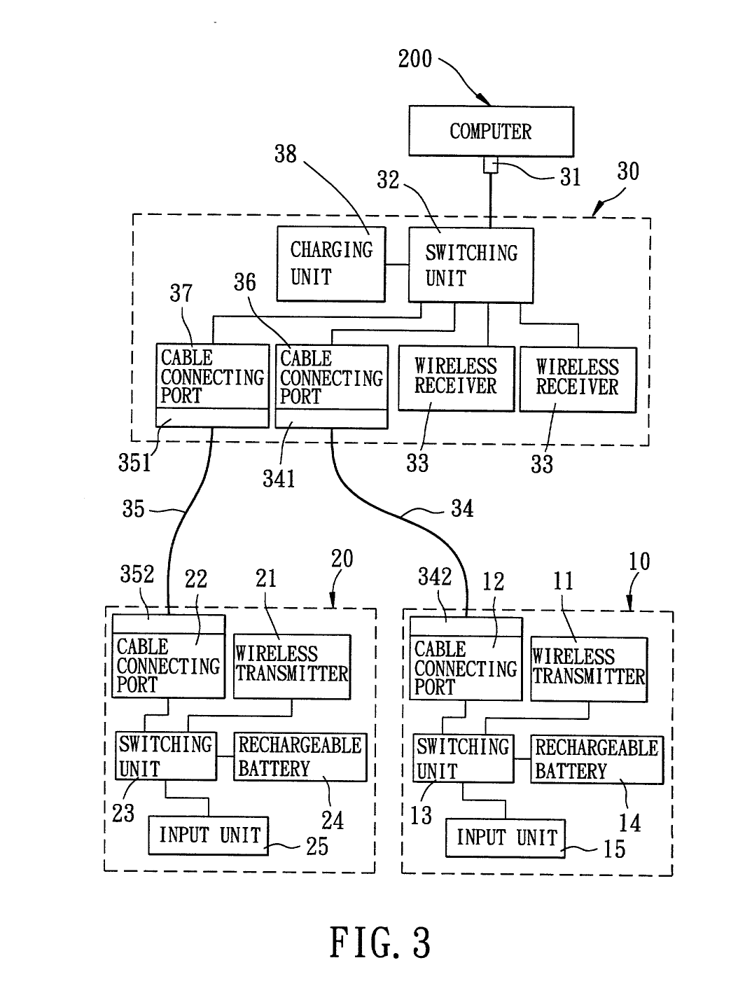

The first input device 10 includes a keyboard unit 15 operable so as to generate a user input signal, a wireless transmitter 11, a first cable connecting port 12, a first switching unit 13 electrically connected to the input unit 15, the wireless transmitter 11 and the first cable connecting port 12, and a rechargeable battery 14 electrically connected to the first switching unit 13 for supplying electrical power to the first input device 10. The wireless transmitter 11 may be an infrared transmitter or a radio frequency transmitter. The first switching unit 13 is operable in a wireless transmission mode (as shown in FIG. 2) wherein the user input signal from the input unit 15 is transmitted wirelessly via the wireless transmitter 11, and a wired transmission mode (as shown in FIG. 3) , wherein wired transmission of the user input signal from the input unit 15 is permitted via the first cable connecting port 12. In one embodiment, the first switching unit 13 is manually operable for switching between the wireless transmission and wired transmission modes. In another embodiment, the first switching unit 13 is capable of switching automatically from the wireless transmission mode to the wired transmission mode when a detecting unit (not shown) of the first switching unit 13 detects presence of electrical connection between a cable 34 and the first cable connecting port 12 (as shown in FIG. 3).

The second input device 20 includes a mouse input unit 25 operable so as to generate a user input signal, a wireless transmitter 21, a first cable connecting port 22, a first switching unit 23 electrically connected to the input unit 25, the wireless transmitter 21 and the first cable connecting port 22, and a rechargeable battery 24 electrically connected to the first switching unit 23 for supplying electrical power to the second input device 20. The wireless transmitter 21 may be an infrared transmitter or a radio frequency transmitter. The first switching unit 23 is operable in a wireless transmission mode (as shown in FIG. 2) , wherein the user input signal from the input unit 25 is transmitted wirelessly via the wireless transmitter 21, and a wired transmission mode (as shown in FIG. 3) , wherein wired transmission of the user input signal from the input unit 25 is permitted via the first cable connecting port 22. In the embodiment, the first switching unit 23 is manually operable for switching between the wireless transmission and wired transmission modes. In another embodiment, the first switching unit 23 is capable of switching automatically from the wireless transmission mode to the wired transmission mode when a detecting unit (not shown) of the first switching unit 23 detects presence of electrical connection between a cable 35 and the first cable connecting port 22 (as shown in FIG. 3).

Referring to FIGS. 2, 3, 4, the control box 30 includes a computer connecting port 31 adapted to be electrically connected to a computer 200, two wireless receivers 33 for receiving the input signal wirelessly transmitted by the wireless transmitters 11, 21, respectively, two second cable connecting ports 36, 37, the cables 34, 35, a second switching unit 32 connected electrically to the computer connecting port 31, the wireless receivers 33 and the second cable connecting ports 36, 37, a charging unit 38 electrically connected to the second switching unit 32, and a charging cable 39 adapted to connect the charging unit 38 to an external power supply 300.

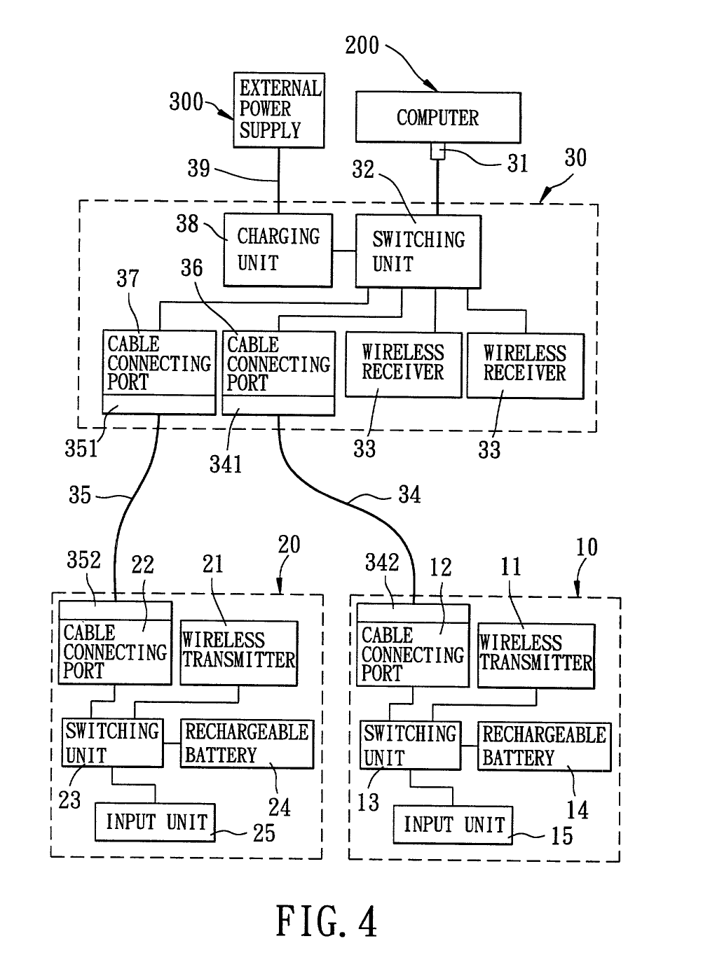

Each of the wireless receivers 33 can be independently an infrared receiver or radio frequency receiver. Each of the cables 34, 35 has a first end 342, 252 connected removably to the first cable connecting port 12, 22 of one of the input devices 10, 20, and a second end 341, 351 connected removably to one of the second cable connecting ports 36, 37. Therefore, wired transmission of the user input signal from the first cable connecting port 12, 22 to the corresponding second cable connecting port 36, 37 is permitted via the cables 34, 35. The second switching unit 32 is operable in a wireless transmission mode (as shown in FIG. 2), wherein the user input signals received by the wireless receivers 33 are provided to the computer connecting port 31 for reception by the computer 200, and a wired transmission mode (as shown in FIGS. 3, 4), wherein the user input signals received by the second cable connecting ports 36, 37 are provided to the computer connecting port 31 for reception by the computer 200. The batteries 14, 24 of the input devices 10 20 are rechargeable batteries which are independently charged by the charging unit 38 when the charging unit 38 is electrically connected to the external power supply 300 via the charging cable 39, and when the second switching unit 32 and the corresponding one of the first switching units 13, 23 operate in the wired transmission mode. Similar to the first switching units 13, 23, the second switching unit 32 may be manually operable for switching between the wireless transmission and the wired transmission modes. Alternatively, the second switching unit 32 may be configured so as to be capable of switching automatically from the wireless transmission mode to the wired transmission mode when a detecting unit (not shown) of the second switching unit 32 detects the presence of the user input signals at the second cable connecting ports 36, 37, i.e. electrical connection is present between the cables 34, 35 and the second cable connecting ports 36, 37.

In view of the aforesaid, the computer user input assembly according to this invention can be readily operated between the wired and wireless transmission modes and does not require frequent battery replacement. Therefore, the computer user input assembly according to this invention can overcome the previously described shortcomings of the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A computer user input assembly with wired and wireless transmission capability, comprising:
an input device including
an input unit operable so as to generate a user input signal,
a wireless transmitter,
a first cable connecting port,
a first switching unit electrically connected to said input unit, said wireless transmitter and said first cable connecting port, said first switching unit being operable in a wireless transmission mode, wherein the user input signal from said input unit is transmitted wirelessly via said wireless transmitter, and a wired transmission mode, wherein wired transmission of the user input signal from said input unit is permitted via said first cable connecting port, and
a battery electrically connected to said first switching unit for supplying electrical power to said input device; and
a control box including
a computer connecting port adapted to be electrically connected to a computer,
a wireless receiver for receiving the input signal wirelessly transmitted by said wireless transmitter,
a second cable connecting port,
a cable having a first end connected removably to said first cable connecting port, and a second end connected to said second cable connecting port, thereby permitting wired transmission of the user input signal from said first cable connecting port to said second cable connecting port, and
a second switching unit connected electrically to said computer connecting port, said wireless receiver and said second cable connecting port, said second switching unit being operable in a wireless transmission mode, wherein the user input signal received by said wireless receiver is provided to said computer connecting port, and a wired transmission mode, wherein the user input signal received by said second cable connecting port is provided to said computer connecting port.

2. The computer user input assembly as claimed in claim 1, wherein said second end of said cable is connected removably to said second cable connecting port.

3. The computer user input assembly as claimed in claim 1, wherein said wireless transmitter is an infrared transmitter, and said wireless receiver is an infrared receiver.

4. The computer user input assembly as claimed in claim 1, wherein said wireless transmitter is a radio frequency transmitter, and said wireless receiver is a radio frequency receiver.

5. The computer user input assembly as claimed in claim 1, wherein said first switching unit is manually operable for switching between the wireless transmission and wired transmission modes.

6. The computer user input assembly as claimed in claim 1, wherein said first switching unit is capable of switching automatically from the wireless transmission mode to the wired transmission mode upon detecting presence of electrical connection between said first end of said cable and said first cable connecting port.

7. The computer user input assembly as claimed in claim 1, wherein said input unit is a keyboard unit.

8. The computer user input assembly as claimed in claim 1, wherein said input unit is a mouse unit.

9. The computer user input assembly as claimed in claim 1, wherein said second switching unit is manually operable for switching between the wireless transmission and wired transmission modes.

10. The computer user input assembly as claimed in claim 1, wherein said second switching unit is capable of switching automatically from the wireless transmission mode to the wired transmission mode upon detecting presence of the user input signal at said second cable connecting port.

11. The computer user input assembly as claimed in claim 2, wherein said second switching unit is capable of switching automatically from the wireless transmission mode to the wired transmission mode upon detecting presence of electrical connection between said second end of said cable and said second cable connecting port.

12. The computer user input assembly as claimed in claim 1, wherein said control box further includes a charging unit electrically connected to said second switching unit and a charging cable adapted to connect said charging unit to an external power supply,
said battery being a rechargeable battery which is charged by said charging unit when said charging unit is electrically connected to the external power supply via said charging cable, and when said first and second switching units operate in the wired transmission mode.
